(19) United States
(12) Patent Application Publication
(10) Pub. No.: US 2005/0103210 A1
(43) Pub. Date: May 19, 2005

(54) Product coating method and apparatus

(76) Inventor: Peter King, Oxford (GB)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/505,161

(22) PCT Filed: Feb. 25, 2003
(86) PCT No.: PCT/GB03/00802

(30) Foreign Application Priority Data
Mar. 1, 2002 (GB) 02047868

(51) Int. Cl. A23C 3/07

(52) U.S. Cl. 99/451

(57) ABSTRACT

A method of coating a product (1), carried on a surface of a delivery mechanism (3), with a coating substance (8). The method comprises delivering the coating substance (8) to a location (15) above said surface carrying said product (1), and allowing the coating substance (8) to fall under gravity in the direction of said surface. During its fall, the coating substance (8) is subjected to at least one pressurised gas stream, and at least one electric field, whereby the failing coating substance (8) is both dispersed and charged.

The present invention relates to a method and apparatus for the coating of products and is applicable in particular, though not necessarily, to a method and apparatus for coating food products.

There exists a wide variety of products which require to be coated with a substance (e.g. powder, liquid, suspension, etc) during their preparation. For example, snack foods such as potato crisps and corn chips are usually coated with a flavouring. It is generally desirable to be able to achieve a uniform and controllable coating over the entire surface of a product. It is also desirable to be able to minimise wastage of the coating substance, and to reduce the dispersion of the coating substance into the environment around the products.

A traditional method used for coating snack foods involves the use of a rotating drum which has its axis generally aligned with the horizontal, but with a slight tilt. Products introduced into one end of the drum tend to travel to the other end as the drum rotates. Flavouring in the form of a powder is delivered via an inclined chute to a location within the drum so that the flavouring is sprinkled onto the products to be coated. This technique tends to result in a non-uniform coating of products, with flavour concentration varying between product pieces and across the surfaces of individual pieces.

It has been recognised that coating uniformity may be improved by placing a charge on the powder grains, using for example a wire electrode located in the transit path of the product. If the product delivery mechanism, e.g. a rotating drum, is grounded, the products to be coating will also tend to be grounded as they pass under the flavouring delivery mechanism. Charged flavouring grains will be attracted to the products in a generally uniform manner, in turn resulting in a generally uniform coating.

U.S. Pat. No. 5,287,801 describes apparatus for coating food products, and which comprises a screw conveyor for delivering a powder coating substance to a delivery chamber. Slots are formed in the base of the delivery chamber so that the delivered substance drops through the slots and falls onto a product delivery conveyor. An electrostatic charging head is located between the delivery chamber and the product delivery conveyor, so that the coating substance falls through an electric field formed by the charging head, acquiring a charge as it does so.

A problem with apparatus of the type described in U.S. Pat. No. 5,287,801 is that the slots in the delivery chamber can become blocked, particularly where the surrounding environment is hot and possibly humid (this is often the case in a food production facility). A further potential problem is that the coating substance is not broken down into sufficiently small grains by the delivery system. Again, this problem may be exacerbated by a warm and humid atmosphere.

An alternative electrostatic coating apparatus comprises a venturi tube through which the coating substance is forced by a pressurised gas. Upon emerging from an exit nozzle, the substance passes over a charging electrode. Again, a blockage problem can arise as the coating substance building up within the venturi tube. Such blockage results in production downtime, increasing operating costs and decreasing productivity.

According to a first aspect of the present invention there is provided a method of coating a product, carried on a surface of a delivery mechanism, with a coating substance, the method comprising:
delivering the coating substance to a location above said surface carrying said product;
allowing the coating substance to fall under gravity in the direction of said surface;
during its fall, subjecting the coating substance to at least one pressurised gas stream, whereby the falling coating substance is dispersed, and to an electric field, whereby the coating substance is charged.

The present invention is applicable in particular to the coating of snack food products with a dry, powdered flavouring. However, the invention may also be used to coat other products including, but not limited to, pharmaceuticals. The invention may also be used to coat products with substances other than dry powdered substances including, for example, liquids and suspensions.

An advantage of the present invention is that the mechanism for delivering the coating substance to a location above the product delivery surface can be made relatively simple. As a pressurised gas is used to disperse the coating substance, there is no need for fine delivery slots or holes which can become easily blocked.

Preferably, the coating substance is delivered to a location above said surface carrying said product via an inclined chute. More preferably, the chute is vibrated or shaken both to disperse the coating substance and to aid transfer of the substance along the chute. Preferably, an exit end of the chute has a width of 75 mm or less.

The coating substance may be delivered to said chute from a supply tank or hopper using, for example, a screw conveyor.

Preferably, the coating substance is subjected to said at least one pressurised gas stream and to said electric field immediately beneath an exit end of the chute.

According to a second aspect of the present invention there is provided apparatus for coating a product, carried on a surface of a delivery mechanism, with a coating substance, the apparatus comprising:
a conveyor for conveying the coating substance to a location above said surface carrying said product, an exit end of the conveyor being suitable for siting above said surface;
a gas jet nozzle for location substantially beneath the exit end of the conveyor;
an electrode attached to or located adjacent to said nozzle;
a source of pressurised gas and means for coupling said source to said gas jet nozzle; and
means for charging said electrode;
wherein in use gas ejected from said nozzle passes over said electrode and is charged, before impinging on the coating substance falling from the exit end of the conveyor.

Preferably, said conveyor is a chute which in use is inclined at an angle to the horizontal. The apparatus may further comprise means for vibrating or shaking the chute.

Preferably, said gas jet nozzle is attached to an underside of the conveyor, so that said nozzle is located directly beneath the exit end of the conveyor. More preferably, any of said gas jet nozzle, said electrode, said source of pressurised gas and said charging means are substantially decoupled from the remainder of said apparatus. An advantage of decoupling these components is that the electrical connections therein are then not subject to the vibrations that they might otherwise be subject to when coupled to the chute.

According to a third aspect of the present invention there is provided apparatus for use in coating a product with a coating substance, the apparatus comprising:
a gas or liquid jet nozzle having means for coupling the nozzle to a supply of pressurised gas or liquid;
a nozzle holder to which the jet nozzle can be removably attached;
a needle electrode attached to the nozzle holder and means for coupling the electrode to a high voltage charging means; and
the needle electrode being located such that in use when gas or liquid is ejected from the nozzle the gas or liquid passes through an electric field created by the electrode.

A needle electrode will generate a charging field which is more efficient at charging a gas or liquid ejected from the nozzle, than alternative electrode designs such as a wire electrode. Preferably, the needle electrode is relatively short, e.g. 1 mm or less.

It will be appreciated that the design of the apparatus makes it easy to change the jet nozzle, e.g. from a nozzle designed to spray gas to a nozzle designed to spray liquid.

For a better understanding of the present invention and in order to show how the same may be carried into effect, reference will now be made to the accompanying drawings in which:

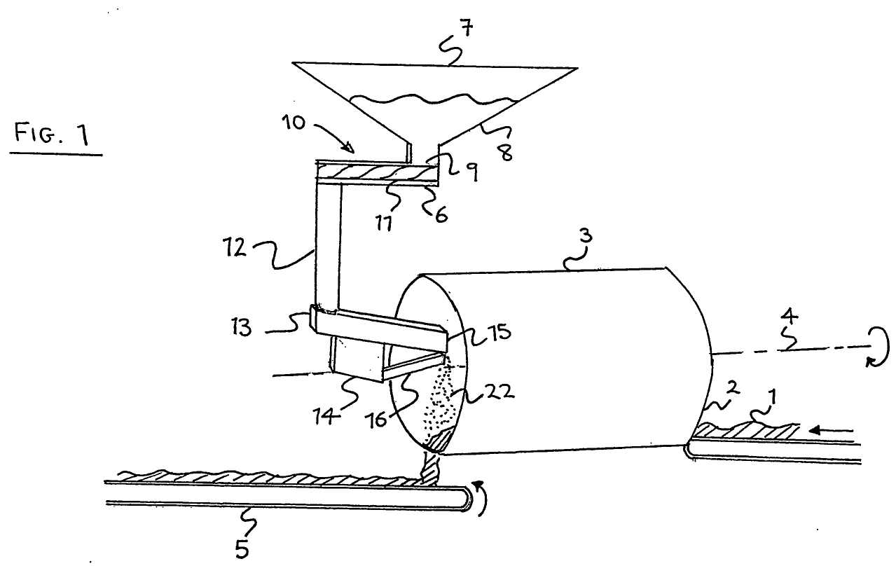

FIG. 1 illustrates in partial cross-section apparatus for coating a snack food with a flavouring;

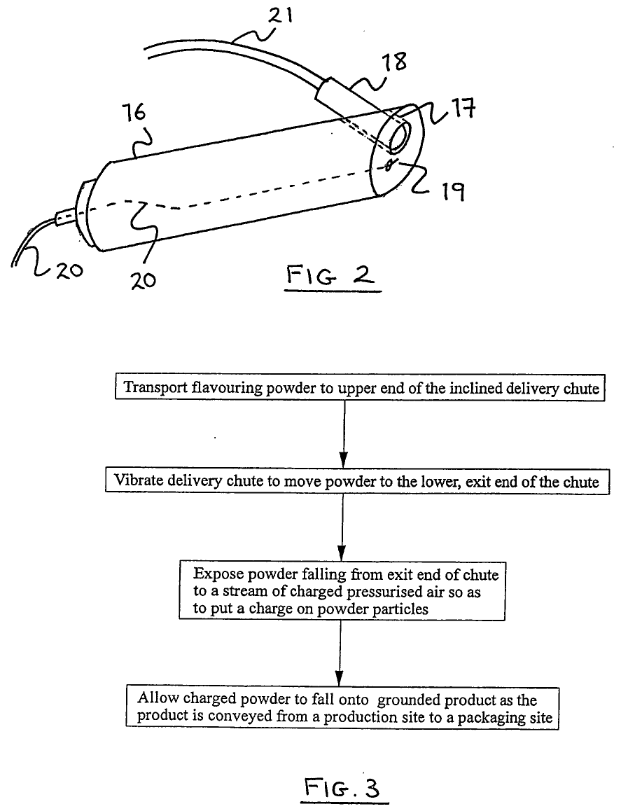

FIG. 2 illustrates a nozzle and nozzle mounting member of the apparatus of FIG. 1; and

FIG. 3 is a flow diagram illustrating a method of coating a snack food with a flavouring;

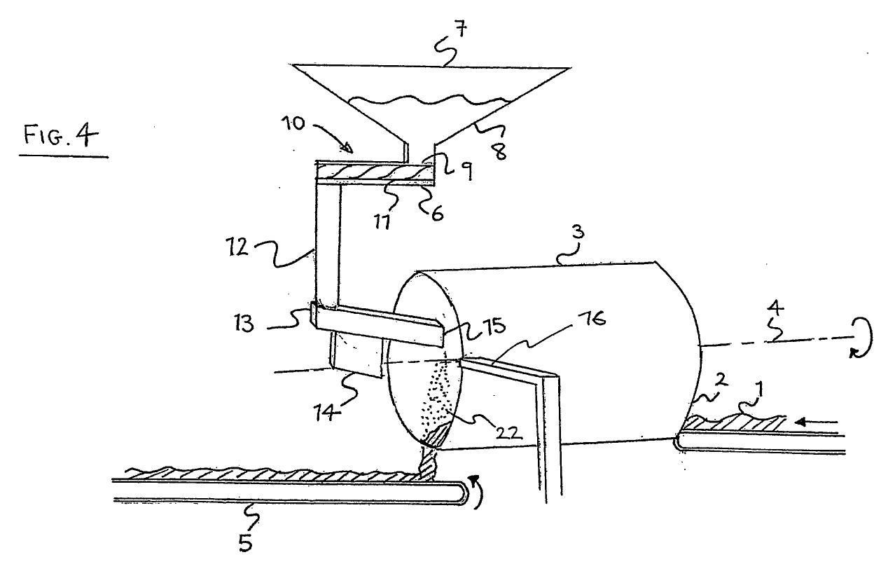

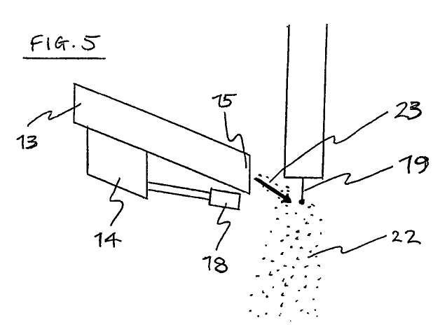

FIG. 4 illustrates in partial cross-section the apparatus of FIG. 1 with the apparatus of FIG. 2 substantially decoupled from the main body of the apparatus; and

FIG. 5 illustrates in side view the apparatus of FIG. 2 with the electrode and charging means of the apparatus substantially decoupled from the nozzle and nozzle mounting member of the apparatus.

There is illustrated in FIG. 1 apparatus for coating a snack food with a flavouring. For the purpose of illustration, it is assumed here that the snack food is potato crisps. Previously baked crisps 1 are fed into an opening 2 at one end of a metal drum 3 which is mounted in a support frame (not shown in the Figure). The drum 3 has its axis 4 oriented substantially horizontally, but tilted at a slight angle (e.g. 10 degrees) thereto, and is rotated (by a mechanism not shown in FIG. 1) so that the crisps travel from the end of the drum at which they enter, to the opposite end. The crisps tumble as they travel, until eventually they fall out of the exit end of the drum 3 onto a moving conveyor 5 which delivers the crisps to packaging apparatus (not shown). The drum is connected to ground potential.

Located on top of a support frame (not shown in FIG. 1) above the drum 3 is a hopper 7 into which is loaded a dry, powdered flavouring 8. An opening 9 in the base of the hopper 7 is coupled to a screw conveyor 10 which comprises a screw 11 mounted within a cylindrical tube 6. The screw 11 is rotated within the cylindrical tube 6 by a suitable motor. An end of the screw conveyor 10 leads into a vertically oriented feed tube 12, the open lower end of which is located directly above an inclined chute 13.

Coupled to an underside of the chute 13 is a vibration motor 14 arranged to vibrate the chute at a relatively high frequency but with a relatively small amplitude. The motor 14 may be for example a model FoodTech FTO1 supplied by FMC.

The lower or exit end 15 of the chute 13 projects into the centre of the drum 3, the exit end having a width of about 25 to 75 mm. A nozzle mounting 16 is located beneath the lower end of the chute 13, and is illustrated in more detail in FIG. 2. The nozzle mounting 16 comprises a single moulded piece of plastics material, having a generally cylindrical passage 17 passing therethrough, close to one end of the mounting 16. The passage is designed to receive a complimentary shaped and sized nozzle 18 which, once inserted into the passage 17, can be secured therein with a screw, clip, or similar fastening.

Fixed into the mounting 16 is a short needle electrode 19, located in the passage 17 just beneath the mouth of the nozzle 18. The electrode 19 is coupled via a conductor 20 to a high voltage charging circuit (for example a cascade arrangement). In use, the electrode is charged up to a voltage of around 85 KV. An end of the nozzle 18 is coupled via a hose 21 to a source of pressurised air (not shown in the figures). The nozzle mounting 16 and the various components attached thereto are designed to withstand the high ambient levels of heat and moisture, and to be suitable for use on a food production line. A suitable control unit is used to control the pressure of air supplied to the nozzle 18 and the voltage applied to the electrode 19.

Having explained the structure of the apparatus with reference to FIGS. 1 and 2, the operation of the apparatus will now be described. With the hopper 7 loaded with flavouring powder 8, the screw conveyor 10 is operated to drive powder 8 into the top of the feed pipe 12. Powder drops through the pipe 12 and lands on the chute 13. Due to the inclined angle of the chute and the vibration of the chute by the motor 14, the powder 8 is conveyed along the chute to its exit end 15. It will be appreciated that vibration of the powder within the chute will result in some dispersion of the powder, i.e. larger lumps will tend to be broken up into smaller lumps or grains.

As the powdered flavouring 8 reaches the exit end 15 of the chute 13, it will spill over the edge and will begin falling under gravity (as indicated by reference numeral 22 in FIG. 1). Directly beneath the exit end 15 of the chute, pressurised air is forced through the nozzle 18 and passes through the electric field created by the charged electrode 19. The air becomes charged as it passes through this field. The charged air then impacts on the falling powder 8, tending to disperse the powder and to break up particles to into micro sizes (i.e. 45-75 microns in diameter). The air also imparts a charge to the powder particles and grains. It is noted that smaller particles (i.e. of micron sizes) accept a charge more easily than larger particles.

As the drum 3 is grounded, the crisps 1 travelling through the drum will also be grounded. The falling, charged powder particles and grains will therefore be accelerated towards the crisps 1, landing on the crisps and coating their exposed surfaces. Due to the electrostatic forces, even back and undersides of the crisps will tend to be coated, resulting in a relatively uniform surface coating. The method described above is further illustrated in the flow diagram of FIG. 3.

It will be appreciated that the apparatus and method described above do not require any small aperture components, e.g. Venturi tubes, slots, or holes, through which the flavouring powder must pass. There is therefore little likelihood of components becoming blocked, resulting in less downtime and higher productivity.

A further embodiment of the invention is illustrated in FIG. 4. All aspects of the apparatus as illustrated in FIGS. 1 and 2 are present, the sole difference being that the nozzle mounting 16 and all components therein are decoupled from the remainder of the apparatus. It will be appreciated that the potentially fragile connections within the nozzle mounting, notably the means for charging the electrode 19, are then not subject to the vibrations of the chute 13.

A further embodiment of the invention, as illustrated in FIG. 5, also adopts this approach. All aspects of the apparatus as illustrated in FIG. 1 are present. The electrode 19 and its charging means, however, are substantially decoupled from the remainder of the nozzle 18 and nozzle mounting member and lie in the path of the falling coating substance. The electrode and its charging means are again isolated from the vibrations of the chute 13. The electrode is positioned substantially proximate to the end 15 of the chute such that a substantial proportion of the falling coating substance is charged. The direction of motion of the coating substance is indicated by arrow 23.

It will be appreciated by the person of skill in the art that various modifications may be made to the above described embodiment without departing from the scope of the present invention. For example, where larger amounts of flavouring must be delivered on top of the product to be coated, a wider chute or multiple chutes, arranged side by side, may be used. A corresponding set of nozzles may be employed to charge and disperse the flavouring. Alternatively, a wide mouthed knife nozzle may be used.

1. A method of coating a product, carried on a surface of a delivery mechanism, with a coating substance, the method comprising:
delivering the coating substance to a location above said surface carrying said product via an inclined chute down which the coating substance falls under gravity;
allowing the coating substance to fall under gravity in the direction of said surface from the end of the inclined chute;
during its fall under gravity, and substantially immediately beneath the exit end of said inclined chute, subjecting the coating substance to at least one pressurised gas stream, whereby the falling coating substance is dispersed, and to an electric field, whereby the coating substance is charged.

2. A method according to claim 1, and comprising vibrating or shaking the chute to disperse the coating substance and to aid transfer of the substance along the chute.

3. A method according to claim 1 or 2, wherein the Pressurized gas stream is subjected to said electric field prior to impinging upon the coating substance.

4. A method according to claim 1, wherein the pressurized gas stream impinges upon the coating substance prior to subjection to said electric field.

5. Apparatus for coating a product, carried on a surface of a delivery mechanism, with a coating substance, the apparatus comprising:
an inclined chute for conveying the coating substance to a location above said surface carrying said product, an exit end of the chute being suitable for siting above said surface;
a gas jet nozzle for location substantially immediately beneath the exit end of the chute;
an electrode attached to or located adjacent to said nozzle:
a source of pressurized gas and means for coupling said source to said gas jet nozzle; and
means for charging said electrode;
wherein in use gas ejected from said nozzle passes over said electrode and is charged, and impinges on the coating substance falling from the exit end of the chute.

6. Apparatus according to claim 5 and comprising means for vibrating or shaking the chute.

7. Apparatus according to claim 5 or 6, wherein in use the gas ejected from said nozzle passes over said electrode prior to impinging upon the coating substance.

8. Apparatus according to claim 5, wherein in use the gas ejected from said nozzle impinges upon the coating substance prior to passing over said electrode.

9. Apparatus for use in coating a product with a coating substance, the apparatus comprising:
a gas or liquid jet nozzle having means for coupling the nozzle to a supply of pressurized gas or liquid;
a nozzle holder to which the jet nozzle can be removably attached;
a needle electrode attached to the nozzle holder and means for coupling the electrode to a high voltage charging means; and
the needle electrode being located such that in use when gas or liquid is ejected from the nozzle the gas or liquid passes through an electric field created by the electrode.

10. (canceled)

11. (canceled)

12. (canceled)
